(19) United States
(12) Patent Application Publication
(10) Pub. No.: US 2024/0141211 A1
(43) Pub. Date: May 2, 2024

(54) BIODEGRADABLE LABELS AND RESIN THEREFOR

(71) Applicant: Danimer IPCo, LLC, Bainbridge, GA (US)

(72) Inventors: Satyabrata Samanta, Bainbridge, GA (US); Adam Johnson, Bainbridge, GA (US); Karson Durie, Athens, GA (US)

(73) Assignee: Danimer IPCo, LLC, Bainbridge, GA (US)

(21) Appl. No.: 18/410,154

(22) Filed: Jan. 11, 2024

Related U.S. Application Data
(62) Division of application No. 17/482,798, filed on Sep. 23, 2021.
(60) Provisional application No. 63/082,565, filed on Sep. 24, 2020.

(51) Int. Cl. C09J 7/38; C09J 7/10; C09J 11/06

(52) U.S. Cl. CPC C09J 7/38; C09J 7/10; C09J 11/06; C09J 2203/334; C09J 2301/408; C09J 2467/00; C09J 2471/00

(57) ABSTRACT

A biodegradable label and a method for making the label. The biodegradable label includes from about 40 to about 99 weight percent of a polymer derived from random monomeric repeating units having a structure of

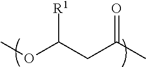

wherein R¹ is selected from the group consisting of CH₃ and a C₃ to C₁₉ alkyl group. The monomeric units having R¹═CH₃ is about 75 to about 99 mol percent of the polymer. A resin adapted for forming the label is also disclosed.

### TECHNICAL FIELD

The disclosure is directed to biodegradable containers and labels therefor and in particular to compositions and methods for making biodegradable labels.

### BACKGROUND AND SUMMARY

With the current plastics crisis, plastics are being continuously replaced with biofriendly alternatives. One large contributor to the plastic problem is poly(ethylene terephthalate) (PET) water bottles. It is estimated that in 2017 one million PET water bottles were sold every minute. Considering that it takes ˜450 years for a PET bottle to completely degrade, the earth is becoming over-polluted with PET bottles. Furthermore, while PET can be recycled, some developed countries, such as the US, only recycle a fraction of the PET bottles used, and other less-developed countries do not have a recycling stream at all. In these countries with no recycling infrastructure, the PET bottles often end up in the ocean, breaking down into microplastics that begin to damage the ecosystem as the marine life consume them, mistaking them for food.

Each part of the bottle plays a role in this issue, including the bottle, label, and closure. While the bottles are made from poly(ethylene terephthalate), the most common material used for these labels is poly(propylene). Poly(propylene) (PP) does not degrade in any significant amount of time, so biofriendly alternatives are necessary to help limit the plastic crisis.

In view of the foregoing, poly(hydroxyalkanoate) (PHA) labels are provided that are highly biodegradable. The PHA labels offer an excellent alternative to PP for labels, as it degrades quickly and can be formulated with the properties necessary to convert resin into films. PHA films have been formulated to be run on both cast and blown film lines, both with and without orientation. The PHA films offer a high Dyne levels giving excellent printability for use in labels. The PHA-based labels are intended to be used in conjunction with PHA-based bottles and PHA-based closures.

In some embodiments, the disclosure provides a biodegradable label. The biodegradable label includes from about 40 to about 99 weight percent of a polymer derived from random monomeric repeating units having a structure of

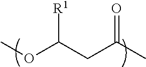

wherein R¹ is selected from the group consisting of CH₃ and/or a C₃ to C₁₉ alkyl group. The monomeric units having R¹═CH₃ is about 75 to about 99 mol percent of the polymer.

In some embodiments, the biodegradable label includes from about 50 to about 80 weight percent of poly(hydroxyalkanoate) copolymer and from about 20 to about 50 wt. % additional additives.

The label also typically includes from about 0.1 to about 3 weight percent of at least one nucleating agent and from about 0.005 to about 3 weight percent of at least one melt strength enhancer.

In some embodiments, the biodegradable label includes poly(hydroxybutyrate) as the poly(hydroxyalkanoate).

In other embodiments, the biodegradable label includes poly-3-hydroxybutyrate-co-3-hydroxyhexanoate (P3HB-co-P3HHx) as the poly(hydroxyalkanoate).

In some embodiments, the label further includes from about 1.0 to about 15.0 weight percent of at least one poly(hydroxyalkanoate) containing from about 25 to about 50 mole percent of a poly(hydroxyalkanoate) selected from poly(hydroxyhexanoate), poly(hydroxyoctanoate), poly(hydroxydecanoate), and mixtures thereof.

In some embodiments, the label further includes poly(hydroxyalkanoate)s that include a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of poly(hydroxyhexanoate), poly(hydroxyoctanoate), poly(hydroxydecanoate), and mixtures thereof.

In other embodiments, the poly(hydroxyalkanoate) polymer has a weight average molecular weight ranging from about 50 thousand Daltons to about 2.5 million Daltons.

In some embodiments, the poly(hydroxyalkanoate) polymer further includes from about 0.1 weight percent to about 3 weight percent of at least one nucleating agent selected from erythritols, pentaerythritol, dipentaerythritols, artificial sweeteners, stearates, sorbitols, mannitols, inositols, polyester waxes, nanoclays, poly(hydroxybutyrate), boron nitride, and mixtures thereof.

In some embodiments, the poly(hydroxyalkanoate) polymer further includes from about 1 weight percent to about 15 weight percent of at least one plasticizer selected from epoxidized soybean oil; L-lactide; an oligomer obtained from the condensation of 7 units of lactic acid; sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

In some embodiments, the label preferably includes from about 0.05 weight percent to about 3 weight percent at least one melt strength enhancer chosen from the group consisting of a multifunctional epoxide; an epoxy-functional, styrene-acrylic polymer; an organic peroxide; an oxazoline; a carbodiimide; and mixtures thereof. In some embodiments, the amount of the melt strength enhancer is from about 0.05 to about 1 weight percent.

In some embodiments, the label further includes from about 1 weight percent to about 50 weight percent of polymers selected from poly(lactic acid), poly(capro-lactone), poly(ethylene sebicate), poly(butylene succinate), and poly(butylene succinate-co-adipate), and copolymers and blends thereof.

In other embodiments, the label further includes from about 0.1 weight percent to about 3 weight percent of a fatty acid amide slip agent.

In some embodiments, the label has Dyne levels of about 30 or greater without surface treatment of the label.

In some embodiments, the biodegradable label is printable using common printing methods selected from the group consisting of flexographic printing, digital printing, and gravure printing.

In some embodiments, the biodegradable label is printable with water-based, solvent-based, and UV inks.

In some embodiments, the biodegradable label is affixable to a bottle or package using a process selected from applying the label with hot melt adhesives, cold adhesives, or water-based adhesives, or applying the label with a shrinkage method.

In some embodiments, the biodegradable label is applicable to a container using commercial labeling equipment.

In other embodiments, there is provided a method for making a biodegradable label that includes forming the label from a poly(hydroxyalkanoate) polymer in a process selected from a film casting process and a film blowing process with or without polymer orientation.

In another aspect, the disclosure also provides a resin which is adapted for forming the biodegradable label described above. The resin is made up of poly(hydroxyalkanoate) and optionally other polymers, as well as other additives as described above with respect to the biodegradable label.

### DETAILED DESCRIPTION

The present invention answers the need for a biodegradable container having a biodegradable container closure, and a label using biodegradable materials that are capable of being easily processed into the container, closure and label. The biodegradable materials and labels made therefrom answer a need for disposable containers having increased biodegradability and/or compostability.

As used herein, “ASTM” means American Society for Testing and Materials.

As used herein, “alkyl” means a saturated carbon-containing chain which may be straight or branched; and substituted (mono- or poly-) or unsubstituted.

As use herein, “Dyne levels” means the surface energy of the materials.

As used herein, “alkenyl” means a carbon-containing chain which may be monounsaturated (i.e., one double bond in the chain) or polyunsaturated (i.e., two or more double bonds in the chain); straight or branched; and substituted (mono- or poly-) or unsubstituted.

As used herein, “film” means an extremely thin continuous piece of a substance having a high length to thickness ratio and a high width to thickness ratio.

As used herein, “PHA” means a poly(hydroxyalkanoate) as described herein having random monomeric repeating units of the formula

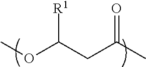

wherein R¹ is selected from the group consisting of CH₃ and a C₃ to C₁₉ alkyl group. The monomeric units wherein R¹═CH₃ are about 75 to about 99 mol percent of the polymer.

As used herein, “P3HB” means the poly-(3-hydroxybutyrate).

As used herein, “P3HHx” means the poly(3-hydroxyhexanoate)

As used herein, “biodegradable” means the ability of a compound to ultimately be degraded completely into CO₂ and water or biomass by microorganisms and/or natural environmental factors, according to ASTM D5511 (anaerobic and aerobic environments), ASTM 5988 (soil environments), ASTM D5271 (freshwater environments), or ASTM D6691 (marine environments). Biodegradability can also be determined using ASTM D6868 and European EN 13432.

As used herein, “compostable” means a material that meets the following three requirements: (1) the material is capable of being processed in a composting facility for solid waste; (2) if so processed, the material will end up in the final compost; and (3) if the compost is used in the soil, the material will ultimately biodegrade in the soil according to ASTM D6400 for industrial and home compostability.

All copolymer composition ratios recited herein refer to mole ratios, unless specifically indicated otherwise.

Unless otherwise noted, all molecular weights referenced herein are weight average molecular weights, as determined in accordance with ASTM D5296.

In one embodiment of the present invention, at least about 50 mol %, but less than 100%, of the monomeric repeating units have CH₃ as R¹, more preferably at least about 60 mol %; more preferably at least about 70 mol %; more preferably at least about 75 to 99 mol %.

In another embodiment, a minor portion of the monomeric repeating units have R¹ selected from alkyl groups containing from 3 to 19 carbon atoms. Accordingly, the copolymer may contain from about 0 to about 30 mol %, preferably from about 1 to about 25 mol %, and more particularly from about 2 to about 10 mol % of monomeric repeating units containing a C₃ to C₁₉ alkyl group as R¹.

In some embodiments, a preferred PHA copolymer for use with the present disclosure is poly-3-hydroxybutyrate-co-3-hydroxyhexanoate (P3HB-co-P3HHx). In certain embodiments, this PHA copolymer preferably comprises from about 94 to about 98 mole percent repeat units of 3-hydroxybutyrate and from about 2 to about 6 mole percent repeat units of 3-hydroxyhexanoate.

### Synthesis of Biodegradable PHAs

Biological synthesis of the biodegradable PHAs in the present invention may be carried out by fermentation with the proper organism (natural or genetically engineered) with the proper feedstock (single or multicomponent). Biological synthesis may also be carried out with bacterial species genetically engineered to express the copolymers of interest (see U.S. Pat. No. 5,650,555, incorporated herein by reference).

### Crystallinity

The volume percent crystallinity (Φ_{c}) of a semi-crystalline polymer (or copolymer) often determines what type of end-use properties the polymer possesses. For example, highly (greater than 50%) crystalline polyethylene polymers are strong and stiff, and suitable for products such as plastic milk containers. Low crystalline polyethylene, on the other hand, is flexible and tough, and is suitable for products such as food wraps and garbage bags. Crystallinity can be determined in a number of ways, including x-ray diffraction, differential scanning calorimetry (DSC), density measurements, and infrared absorption. The most suitable method depends upon the material being tested.

The volume percent crystallinity (Φ_{c}) of the PHA copolymer may vary depending on the mol percentage of P3HHx in the PHA copolymer. The addition of P3HHx effectively lowers the volume percent crystallinity of the PHA copolymer, crystallization rate, and melting temperature while providing an increase in the flexibility and degradability of the copolymer. Nucleating agents, as described herein may be used to speed up the crystallization process of the PHA copolymers.

In general, PHAs of the present invention preferably have a crystallinity of from about 0.1% to about 99% as measured via x-ray diffraction; more preferably from about 2% to about 80%; more preferably still from about 20% to about 70%.

When a PHA of the present invention is to be processed into a molded article or film, the amount of crystallinity in such PHA is more preferably from about 10% to about 80% as measured via x-ray diffraction; more preferably from about 20% to about 70%; more preferably still from about 30% to about 60%.

### Melt Temperature

Preferably, the biodegradable PHAs of the present invention have a melt temperature (Tₘ) of from about 30° C. to about 170° C., more preferably from about 90° C. to about 165° C., more preferably still from about 130° C. to about 160° C.

### Film Products

According to the disclosure, a polymeric label is formed from polymer or copolymer materials (e.g., PHA) which is cast or blown by means of a gas into continuous film. In particular, the films may be plastic labels for bottles or other containers. One problem with polymeric films made from petroleum products is that the surface energy of the films is typically too low to provide a suitable surface for accepting printing inks. Accordingly, surface treatment of petroleum-based films is often required to increase the surface energy of the films. In contrast to the petroleum-based films, the PHA labels of the present invention have a relatively high surface energy, i.e., Dyne levels of about 30 or greater.

Applicants have found that PHA copolymers of the present invention having random monomeric repeating units of the formula

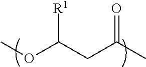

wherein R¹ is selected from the group consisting of CH₃ and a C₃ to C₁₉ alkyl group, and wherein the monomeric units having R¹═CH₃ comprise about 75 to about 99 mol percent of the polymer have a) a lower melt temperature, b) a lower degree of crystallinity, and c) an improved melt rheology.

The films for use as labels as described herein have a thickness with an upper limit of about 2 mils, such as from about 1 mil to about 1.5 mils. In addition to increased biodegradability and/or compostability, the films as described herein have the following properties:
a) a machine direction (MD) Secant modulus (1%) ranging from about 1606 MN/m² to about 2211 MN/m²,
b) a transverse direction (TD) Secant modulus (1%) ranging from about 1810 MN/m² to about 2374 MN/m²,
c) a MD tear strength of at least 7.0 grams per mil of thickness,
d) a cross machine direction (CD) tear strength of at least 18 grams per mil of thickness.

### Method of Film Manufacture

The films of the present invention used as container labels having increased biodegradability and/or compostability may be processed using conventional procedures for producing single or multilayer films on conventional film-making equipment. Resin pellets of the PHAs of the present invention may be dry blended and then melt mixed in a film extruder. Alternatively, if insufficient mixing occurs in the film extruder, the resin pellets may be dry blended and then melt mixed in a pre-compounding extruder followed by repelletization prior to film extrusion.

The PHAs of the present invention can be melt processed into films using either cast or blown film extrusion methods both of which are described in PLASTICS EXTRUSION TECHNOLOGY—2nd Ed., by Allan A. Griff (Van Nostrand Reinhold-1976). In a cast film process, the molten polymer mixture is extruded through a linear slot die. Generally, the flat web is cooled on a large moving polished metal roll. The web quickly cools, and peels off this first roll, passes over one or more auxiliary cooling rolls, then through a set of rubber-coated pull or “haul-off” rolls, and finally to a winder.

In a blown film extrusion process, the molten polymer formulation is extruded upward through a thin annular die opening. The blown film process is also referred to as tubular film extrusion. Air is introduced through the center of the die to inflate the tube causing it to expand. A moving bubble is thus formed which is held at a constant size by control of internal air pressure. The tube of film is cooled by air, blown through one or more chill rings surrounding the tube. The tube is then collapsed by drawing it into a flattening frame through a pair of pull rolls and into a winder. For label applications the flattened tubular film is subsequently slit open, unfolded, and further slit into widths appropriate for use as labels.

Both cast film and blown film processes may be used to produce either monolayer or multilayer film structures. For the production of monolayer films from a single thermoplastic material or blend of thermoplastic components only a single extruder and single manifold die are required.

For the production of multilayer films, coextrusion processes are preferably employed. Such processes require more than one extruder and either a coextrusion feed-block or multi-manifold die system or combination of the two to achieve the multilayer film structure.

PHA labels for containers are made by modifying PHA with melt strength enhancers, chain extenders, and other processing aids.

The PHAs according to the disclosure may contain from about 50 to 80 weight percent of poly(hydroxyalkanoate) copolymer and from about 20 to about 50 wt. % polymer modifiers. In some embodiments, the poly(hydroxyalkanoate) copolymer is poly-3-hydroxybutyrate-co-3-hydroxyhexanoate (P3HB-co-P3HHx). In other embodiments, the PHA composition includes from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

In some embodiments, the PHA resin formulation used to make biodegradable labels may include from about 0.5 weight percent to about 15 weight percent of at least one plasticizer selected from the group consisting of sebacates, citrates, fatty esters of adipic, succinic, and glucaric acids, lactates, lactides, alkyl diesters, citrates, alkyl methyl esters, dibenzoates, propylene carbonate, caprolactone diols having a number average molecular weight from 200-10,000 g/mol, polyethylene glycols having a number average molecular weight of 400-10,000 g/mol, esters of vegetable oils, epoxidized soybean oil, long chain alkyl acids, lactic acid oligomers, adipates, glycerol, isosorbide derivatives or mixtures thereof.

In other embodiments, the PHA resin formulation preferably also includes from about 0.1 weight percent to about 3 weight percent of at least one nucleating agent selected from sulfur, erythritols, pentaerythritol, dipentaerythritols, inositols, stearates, sorbitols, mannitols, polyester waxes, compounds having a 2:1; 2:1 crystal structure chemicals, boron nitride, and mixtures thereof.

In some embodiments, the PHA resin formulation preferably includes from about 0 to about 1 percent by weight, such as from about 1 to about 0.5 percent by weight of a melt strength enhancer/rheology modifier. This melt strength enhancer may for instance be selected from the group consisting of a multifunctional epoxide; an epoxy-functional, styrene-acrylic polymer; an organic peroxide such as di-t-butyl peroxide; an oxazoline; a carbodiimide; and mixtures thereof.

Without being bound by theory, this additive is believed to act as a cross-linking agent to increase the melt strength of the PHA formulation. Alternatively, in some instances, the amount of the melt strength enhancer is from about 0.05 to about 3 weight percent. More preferred melt strength enhancers include organic peroxides, epoxides, and carbodiimides, preferably in an amount from about 0.05 to about 0.2 weight percent of the PHA formulation.

In some embodiments, the PHA resin formulation may include one or more performance enhancing polymers selected from poly(lactic acid), poly(caprolactone), poly(ethylene sebicate), poly(butylene succinate), and poly(butylene succinate-co-adipate) (PBSA), and copolymers and blends thereof. The performance enhancing polymers may be present in the formulation in a range of from about 1 to about 50 percent by weight.

PBSA is a biodegradable, semi-crystalline produced by co-condensation of succinic and adipate acid with 1-4-butanediol. All three building blocks can be produced either from renewable feedstock such as glucose and sucrose via fermentation or from petroleum-based feedstock.

In some embodiments, the polymer resin formulation includes from about 1 to about 3 weight percent of a slip agent. The most common slip agents are long-chain, fatty acid amides, such as erucamide and oleamide. One or more slip agents, for example calcium stearate or fatty acid amides is/are typically included in the polymer formulation.

Exemplary formulations that may be used to make biodegradable labels according to the disclosure are shown in the following table.

| | PHA | | | | |
|---|---|---|---|---|---|
| | polymer | Weight | Weight | | Weight % |
| | wt. % | % | % | | Poly |
| | 6 mol % | Poly- | Poly- | | (butylene |
| | Hexanoate | lactic | ethylene | Weight % | succinate- |
| Formula | in polymer | acid | Glycol | Pentaerythritol | adipate) |
| 1 | 60 | 36 | 3 | 1 | 1.5 |
| 2 | 60 | 39 | — | 1 | 1.5 |
| 3 | 70 | 29 | — | 1 | 1.5 |
| 4 | 70 | 26 | 3 | 1 | 2 |
| 5 | 70 | 19 | — | 1 | 10 |
| 6 | 70 | 16 | 3 | 1 | 10 |

With the formulations provided, the PHA should degrade rapidly, but the degradation kinetics will depend on the thickness of the label, with thicker label materials taking longer to fully degrade. The labels are suitable for common printing methods without surface treatment, including flexographic printing, digital ink jet printing, and gravure printing using water-based inks, solvent-based inks, and UV inks.

The labels may be applied to containers or packages using hot melt adhesives, cold adhesives, or water-based adhesives or by use of a shrink-wrap method. Shrink-wrap is particularly useful for plastic bottles. The labels may also be applied to containers and packages using commercial labeling equipment.

PHA films have been formulated to be run on both cast and blown film lines, both with and without orientation. The PHA films offer excellent barrier for use in packaging applications and high Dyne levels giving excellent printability for use in labels. Several formulations have been tested in making PHA films, and these formulations may be changed and optimized for individual applications and equipment.

The present disclosure is also further illustrated by the following embodiments:

Embodiment 1. A biodegradable label comprising: from about 0.1 to about 3 weight percent of at least one nucleating agent; from about 0.05 to about 3 weight percent of at least one melt strength enhancer; and from about 40 to about 99 weight percent of a polymer derived from random monomeric repeating units having a structure of

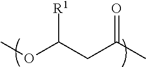

wherein R¹ is selected from the group consisting of CH₃ and a C₃ to C₁₉ alkyl group, wherein the monomeric units having R¹═CH₃ comprise 75 to 99 mol percent of the polymer.

Embodiment 2. The biodegradable label Embodiment 1, wherein the label comprises from about 50 to about 80 weight percent of poly(hydroxyalkanoate) copolymer and from about 20 to about 50 wt. % additional additives.

Embodiment 3. The biodegradable label of Embodiment 2 wherein the poly(hydroxyalkanoate) copolymer comprises poly-3-hydroxybutyrate-co-3-hydroxyhexanoate (P3HB-co-P3HHx).

Embodiment 4. The biodegradable label of Embodiment 1, wherein the label further comprises from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

Embodiment 5. The biodegradable label of Embodiment 1, wherein the label further comprises poly(hydroxyalkanoate)s comprising a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of poly(hydroxyhexanoate), poly(hydroxyoctanoate), poly(hydroxydecanoate), and mixtures thereof.

Embodiment 6. The biodegradable label of Embodiment 1, wherein the polymer has a weight average molecular weight ranging from about 50 thousand Daltons to about 2.5 million Daltons.

Embodiment 7. The biodegradable label of Embodiment 1, wherein the polymer further comprises from about 0.1 weight percent to about 3 weight percent of at least one nucleating agent selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

Embodiment 8. The biodegradable label of Embodiment 1, wherein the polymer further comprises from about 1 weight percent to about 15 weight percent of at least one plasticizer selected from the group consisting of sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

Embodiment 9. The biodegradable label of Embodiment 1, wherein the label comprises from about 0.05 weight percent to about 3 weight percent at least one melt strength enhancer selected from the group consisting of a multifunctional epoxide; an epoxy-functional, styrene-acrylic polymer; an organic peroxide; an oxazoline; a carbodiimide; and mixtures thereof.

Embodiment 10. The biodegradable label of Embodiment 1, wherein the label further comprises from about 1 weight percent to about 50 weight percent of polymers selected from the group consisting of poly(lactic acid), poly(caprolactone), poly(ethylene sebicate), poly(butylene succinate), and poly(butylene succinate-co-adipate), and copolymers and blends thereof.

Embodiment 11. The biodegradable label of Embodiment 1, wherein the container label further comprises from about 0.1 weight percent to about 3 weight percent of a fatty acid amide slip agent.

Embodiment 12. The biodegradable label of Embodiment 1, wherein the label has Dyne levels of about 30 or greater without surface treatment of the label.

Embodiment 13. The biodegradable label of Embodiment 1, wherein the label is printable using common printing methods selected from the group consisting of flexographic printing, digital printing, and gravure printing.

Embodiment 14. The biodegradable label of Embodiment 1, wherein the label is printable with water-based, solvent-based, and UV inks.

Embodiment 15. The biodegradable label of Embodiment 1, wherein the label is affixable to a bottle or package using a process selected from the group consisting of applying the label with a shrinkage method and applying the label with a hot melt adhesive, a cold adhesive, or a water-based adhesive.

Embodiment 16. The biodegradable label of Embodiment 1, where the label is applicable to a container using commercial labeling equipment.

Embodiment 17. A method for making a biodegradable label from the polymer of Embodiment 1 comprising forming the label from a poly(hydroxyalkanoate) polymer in a process selected from the group consisting of a film casting process and a film blowing process with or without polymer orientation.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A biodegradable label comprising:
from about 40 to about 99 weight percent of a poly(hydroxyalkanoate) copolymer derived from random monomeric repeating units having a structure of 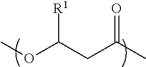
wherein R¹ is selected from the group consisting of CH₃ and a C₃ to C₁₉ alkyl group, wherein the copolymer comprises 75-99 mol % monomeric units having R¹ being CH₃ and the balance of monomeric units having R¹ being selected from C₃ to C₁₉ alkyl groups, wherein the poly(hydroxyalkanoate) copolymer comprises poly-3-hydroxybutyrate-co-3-hydroxyhexanoate (P3HB-co-P3HHx) and from about 20 to about 50 wt. % additional additives, wherein the additional additives comprise from about 0.1 to about 3 weight percent of at least one nucleating agent, and from about 0.05 to about 3 weight percent of a melt strength enhancer consisting essentially of a mixture of an organic peroxide and an oxazoline.

2. The biodegradable label of claim 1, wherein the biodegradable label comprises from about 50 to about 80 weight percent of poly(hydroxyalkanoate) copolymer.

3. (canceled)

4. The biodegradable label of claim 1, wherein the biodegradable label further comprises from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

5. The biodegradable label of claim 1, wherein the biodegradable label further comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyoctanoate, 3-hydroxydecanoate, and mixtures thereof.

6. The biodegradable label of claim 1, wherein the poly(hydroxyalkanoate) copolymer has a weight average molecular weight ranging from about 50 thousand Daltons to about 2.5 million Daltons.

7. The biodegradable label of claim 1, wherein the at least one nucleating agent is selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

8. The biodegradable label of claim 1, wherein the additional additives further comprise from about 1 weight percent to about 15 weight percent of at least one plasticizer selected from the group consisting of sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

9. (canceled)

10. The biodegradable label of claim 1, wherein the biodegradable label further comprises from about 1 weight percent to about 50 weight percent of polymers selected from the group consisting of poly(lactic acid), poly(caprolactone), poly(ethylene sebacate), poly(butylene succinate), and poly(butylene succinate-co-adipate), and copolymers and blends thereof.

11. The biodegradable label of claim 1, wherein the additional additives further comprise from about 0.1 weight percent to about 3 weight percent of a fatty acid amide slip agent.

12. The biodegradable label of claim 1, wherein the biodegradable label has Dyne levels of about 30 or greater without surface treatment of the biodegradable label.

13. The biodegradable label of claim 1, wherein the biodegradable label is printable using common printing methods selected from the group consisting of flexographic printing, digital printing, and gravure printing.

14. The biodegradable label of claim 1, wherein the biodegradable label is printable with water-based, solvent-based, and UV inks.

15. The biodegradable label of claim 1, wherein the biodegradable label is affixable to a bottle or package using a process selected from the group consisting of applying the biodegradable label with a shrinkage method and applying the biodegradable label with a hot melt adhesive, a cold adhesive, or a water-based adhesive.

16. The biodegradable label of claim 1, where the biodegradable label is applicable to a container using commercial labeling equipment.

17. A method for making a biodegradable label from the poly(hydroxyalkanoate) copolymer of claim 1, comprising forming the biodegradable label in a process selected from the group consisting of a film casting process and a film blowing process with or without polymer orientation.
